(19) United States
(12) Patent Application Publication
(10) Pub. No.: US 2006/0207852 A1
(43) Pub. Date: Sep. 21, 2006

(54) Hydrodynamic clutch device

(75) Inventor: Thomas Adelmann, Retzstadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/352,880

(22) Filed: Feb. 13, 2006

(30) Foreign Application Priority Data
Mar. 17, 2005 (DE) 10 2005 012 818.1

(51) Int. Cl. F16H 45/02

(52) U.S. Cl. 192/3.29

(57) ABSTRACT

A hydrodynamic clutch device has at least one pump wheel, connected to a drive by way of a clutch housing, and a turbine wheel, connected to a takeoff, to form a hydrodynamic circuit. The device also has a bridging clutch with at least one piston, which can shift between a released position and an engaged position, and at least one friction surface acting between this piston and an adjacent support to connect the drive to the takeoff. When the piston is in the released position, the bridging clutch allows the hydrodynamic circuit to be used to transmit at least most of the torque between the drive and takeoff, whereas, when the piston is in the engaged position, the bridging clutch produces a bypass around the hydrodynamic circuit for the transmission of torque. A pressure circuit is provided in the form of a two-line system with a first pressure medium line to supply the hydrodynamic circuit with clutch fluid and with a second pressure medium line to supply a pressure space assigned to the piston with clutch fluid. A flow velocity influencing device is assigned to the hydrodynamic circuit and/or to the pressure space, located in each case axially between the piston and a component at least indirectly adjacent to the piston.

### BACKGROUND OF THE INVENTION

1. Field of the Invention

The invention pertains to a hydrodynamic clutch device including a pump wheel, a housing connecting the pump wheel to a drive, and a turbine wheel connected to a takeoff, the turbine wheel being located in the housing and cooperating with the pump wheel to form a hydrodynamic circuit.

2. Description of the Related Art

U.S. Pat. No. 5,575,363 describes a hydrodynamic clutch device designed as a hydrodynamic torque converter. This device comprises a clutch housing, which is brought into connection in the conventional manner for rotation in common with a drive, such as an internal combustion engine, and a pump wheel, which works together with a turbine wheel and a stator to form a hydrodynamic circuit. Whereas the turbine wheel is connected nonrotatably to the takeoff, such as a gearbox input shaft, the stator is mounted by way of a freewheel on a support shaft, which is provided radially between a pump wheel hub and the gearbox input shaft. In addition, the hydrodynamic clutch device has a bridging clutch with a piston, which is connected nonrotatably but with freedom of axial movement to the clutch housing.

The hydrodynamic clutch device is designed as a two-line system, as a result of which the following pressure and flow conditions are produced:

A first pressure medium line is connected to a first flow route, which has flow channels radially between the pump wheel hub and the support shaft and additional flow channels radially between the support shaft and the gearbox input shaft. This first pressure medium line is formed by flow channels provided in the thrust washers located on both sides of the freewheel of the stator. Clutch fluid is supplied to the hydrodynamic circuit through these channels. When there is a positive pressure in the hydrodynamic circuit, the piston is pushed toward the adjacent housing cover of the clutch housing; friction surfaces then allow the piston to be carried along rotationally by the clutch housing. Conversely, this rotation in common produced by the friction surfaces is released when, through a second pressure medium line, a pressure space assigned to the piston and located axially between the piston and the housing cover is supplied with a positive pressure versus the hydrodynamic circuit, as a result of which the piston is pushed axially toward the hydrodynamic circuit. The second pressure medium line is connected to a second flow route, which passes by way of a center bore in the gearbox input shaft. Each of the two flow routes is connected to a fluid reservoir.

The essential principle of a two-line system of this type—but also its essential disadvantage—is the installation of the bridging clutch as a separation point between the hydrodynamic circuit and the pressure space. When the bridging clutch is open, therefore, a connection exists between the hydrodynamic circuit and the pressure space, which allows the pressure to equalize at least in the area of the radial extension of the bridging clutch, whereas, when the bridging clutch is closed, a pressure which can differ considerably from that in the pressure space can easily build up in the hydrodynamic circuit, even in direct proximity to the bridging clutch.

Especially during operation in push mode, that is, when the takeoff rpm's are higher than the drive rpm's, this situation has disadvantageous effects as soon as the bridging clutch is to be closed for the purpose of taking advantage of the braking action of the drive to reduce or avoid a long period of efficiency-impairing slippage or to prevent an unbraked acceleration of the drive upon a sudden transition from push mode to pull mode. The following unpleasant effect then occurs:

As a result of the filling of the hydrodynamic clutch device with clutch fluid, this fluid pushes its way radially outward under the effect of centrifugal force, and ideally we can assume a pressure of “zero” at the center of rotation of the clutch device. As the distance from the center of rotation increases, however, the pressure values increase monotonically, near-maximum values being reached in the area of the radial extension of the bridging clutch, which is usually located in the radially outer area of the device. The increase in these pressure values during operation in push mode is more pronounced in the hydrodynamic circuit than in the pressure space, because the clutch fluid in the pressure space rotates essentially at the same speed as the clutch housing, whereas in the hydrodynamic circuit it rotates at the higher takeoff side speed of the turbine wheel. Under consideration of the boundary condition that, when the bridging clutch is open, the pressure conditions within the area of the radial extension of the bridging clutch are equalized between the hydrodynamic circuit and in the pressure space, the difference between the pressure-increase curves on the two sides of the piston have the effect that the course of the pressure increase in the pressure space—starting from the area of the radial extension of the bridging clutch and leading radially inward from there—undergoes less of a pressure drop than the course of the pressure increase on the opposite side of the piston, that is, in the hydrodynamic circuit. The consequence of this is that the pressure in the part of the pressure space radially inside the bridging clutch is higher than that in the hydrodynamic circuit, as a result of which the piston is held stably in the released position. If, under these conditions, an actuating command is given to close the bridging clutch, a positive pressure must first be built up in the hydrodynamic circuit which significantly exceeds the pressure in the pressure space. There is a therefore a considerable delay in the closing of the bridging clutch.

As soon as the piston of the bridging clutch starts moving toward its engaged position after the necessary high positive pressure has been built up in the hydrodynamic circuit, the connection between the hydrodynamic circuit and the pressure space becomes smaller and thus acts increasingly as a throttle, which has the effect of lowering the pressure in the pressure space below that present in the hydrodynamic circuit and thus ultimately causes the sign of the axial force acting on the piston to reverse. Although the piston would thus now be able to shift into its engaged position by itself, the high positive pressure built up in the hydrodynamic circuit—which had no effect previously while the piston was not moving—now goes suddenly into effect, exerting a strong axial force which accelerates the engaging movement of the piston, so that the piston travels at a very high velocity over the last part of its engaging stroke and thus enters into working connection with the axially adjacent, drive side component of the clutch housing, such as, for example, a housing cover, in a very abrupt manner. As a result, the speed difference previously existing between the drive and the takeoff disappears within a very short time. In a vehicle traveling in push mode, this process is felt as an unpleasantly hard torque surge and detracts from the comfort of the vehicle's passengers.

### SUMMARY OF THE INVENTION

The invention is based on the task of designing a hydrodynamic clutch device with a bridging clutch in such a way that the bridging clutch can be closed without causing a surge in the torque even during operation in push mode.

This task is accomplished by a hydrodynamic clutch device having a flow influencing device located axially adjacent to the piston in at least one of the pressure space and the hydrodynamic circuit. By installing a flow velocity influencing device inside the hydrodynamic circuit, the flow velocity prevailing there is decelerated, whereas, through the installation of the flow velocity influencing device in the pressure space, the effect is achieved there of accelerating the prevailing flow velocity. As a result, the flow velocities in the hydrodynamic circuit and in the pressure space are brought closer together, which has an effect on the pressure conditions in the two spaces, as will be explained below.

Pressure increase curves which rise in an essentially monotonic manner between the axis of rotation and the area of the radial extension of the bridging clutch develop both in the hydrodynamic circuit and in the pressure space. Because of the higher rotational speed of the turbine wheel on the takeoff side in push mode, the pressure curve in the hydrodynamic circuit rises more quickly than that in the pressure space on the opposite side of the piston. Because of the decrease in the flow velocity in the hydrodynamic circuit and/or the increase in the flow velocity in the pressure space—caused in each case by the flow velocity influencing device—however, an effect is exerted on the pressure increase curves present in the hydrodynamic circuit and/or in the pressure space with the result that the two curves approach each other. As a result, the pressure equalization which tends to occur in the area of the radial extension of the bridging clutch when the bridging clutch is open is hardly perceptible at all in the sense that the positive pressure which would otherwise develop radially inside the bridging clutch because of the flatter pressure increase curve in comparison with that in the hydrodynamic circuit and which would make it more difficult to engage the piston and thus to close the bridging clutch does not, in fact, occur. The buildup of this positive pressure in the pressure space is accordingly avoided almost completely by the flow velocity influencing device.

Because the flow velocity influencing device causes the pressure-increase curve in the hydrodynamic circuit and the pressure-increase curve in the pressure space to become more similar to each other, the piston requires only a slight positive pressure on the hydrodynamic circuit side to push it toward the pressure space when the clutch engaging process is initiated, especially during operation in push mode, that is, when the rpm's at the takeoff, such as at the turbine wheel, are higher than those at the drive, such as at the clutch housing, especially the drive side housing cover.

Independently of the flow velocity influencing device, full pressure is always being applied to the side of the piston facing the hydrodynamic circuit to engage the piston and thus to close the bridging clutch, which means that the engaging movement of the piston can occur with the maximum pressure boost from the hydrodynamic circuit and high torques can be transmitted from the drive while the piston remains engaged. Because the pressures in the hydrodynamic circuit and in the pressure space have been brought close to each other by the flow velocity influencing device, the absolute value of the pressure difference which must be built up between the hydrodynamic circuit and the pressure space can be very small, and as a result there will be no abrupt torque surges when the piston engages. To this extent the passengers of a vehicle equipped with this type of clutch device will enjoy a very comfortable ride. Simultaneously, because of the nearly complete absence of delay in the engagement of the piston, power-reducing and/or efficiency-impairing operating phases of the hydrodynamic clutch device can be almost completely avoided even during operation in push mode. Of course, even when an abrupt transition is made from push mode to pull mode, the quickness of the reaction during the closing of the bridging clutch means that the drive, which would be nearly free of inertia because of the absence of load on the takeoff side, is also prevented from racing.

The flow velocity influencing device is preferably designed as a ring shaped component surrounding the axis of rotation of the hydrodynamic clutch device. For functional reasons, the flow velocity influencing device will be designed as a flow-decelerating device in the hydrodynamic circuit and as a flow-accelerating device in the pressure space. The flow velocity influencing elements such as tabs will thus be provided on the base carrier of the flow velocity influencing device in such a way as to project into the flow path of the clutch fluid. With respect to their circumferential alignment on the base carrier, these velocity influencing elements will obviously be oriented against the flow direction of the clutch fluid in the hydrodynamic circuit, so that they will decrease the flow velocity there, whereas they will be oriented in the flow direction in the pressure space in order to increase the flow velocity there, thus fulfilling the task of a flow velocity influencing device in both situations.

The flow velocity influencing elements of the flow velocity influencing device are preferably designed as a tab-shaped flow guide elements, which, for fabrication reasons, are first preferably freed on three sides from the base carrier of the flow velocity influencing elements and then subjected to plastic deformation to shift them axially out of the plane of the base body and into the flow path of the clutch fluid. The base body itself can be subjected to plastic deformation and thus profiled in such a way as to increase its stiffness. In correspondence with the specific requirements, this increase in stiffness will have its effect essentially in the axial direction, whereas the profiling will extend essentially in the radial and/or circumferential direction.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows the upper half of a longitudinal section through a hydrodynamic torque converter with a bridging clutch of the two-line design and with one flow velocity influencing device in the hydrodynamic circuit and another in a pressure space;

FIG. 2 shows an enlarged detail of an angular segment of the flow velocity influencing device, in a direction parallel to the axis of rotation of the hydrodynamic torque converter;

FIG. 3 shows a cross section of the flow velocity influencing device along line III-III of FIG. 2; and

FIG. 4 is similar to FIG. 3 except that the flow velocity influencing device is acting in the opposite direction.

### DETAILED DESCRIPTION OF THE PRESENTLY PREFERRED EMBODIMENTS

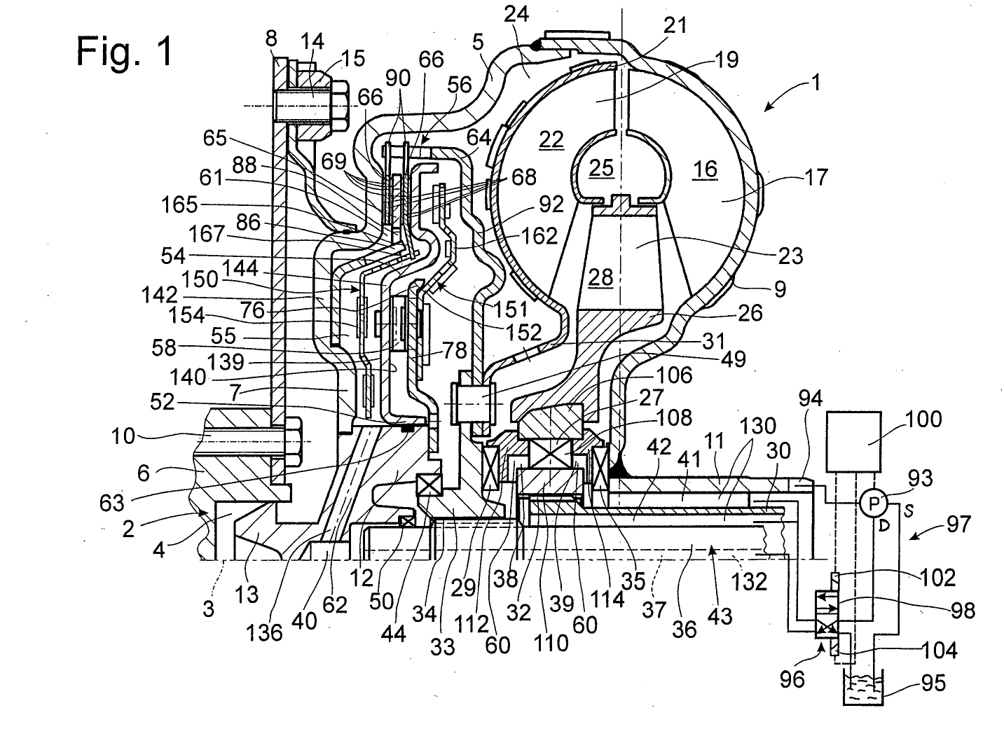

FIG. 1 shows a hydrodynamic clutch device 1 in the form of a hydrodynamic torque converter, which is able to execute rotational movement around an axis of rotation 3. The hydrodynamic torque converter has a clutch housing 5 with a housing cover 7 on the side facing a drive 2, such as an internal combustion engine with a crankshaft 6. The housing cover is permanently connected to a pump wheel shell 9. This shell merges in its radially inner area with a pump wheel hub 11.

In its radially inner area, the housing cover 7 has a journal hub 12, which carries a bearing journal 13. The bearing journal 13 is held in a recess 4 in the crankshaft 6 for the purpose of centering the clutch housing 5 on the drive side. The housing cover 7 also has a fastening mount 15, by which the clutch housing 5 is fastened to the crankshaft 6 by way of a flexplate 8, this being accomplished by the use of fastening elements 14, preferably in the form of screws. The flexplate 8 for its own part is fastened to the crankshaft 6 by fastening elements 10, also preferably in the form of screws.

The previously mentioned pump wheel shell 9 works together with pump wheel vanes 16 to form a pump wheel 17. The pump wheel interacts with a turbine wheel 19, which has both a turbine wheel shell 21 and turbine wheel vanes 22, and with a stator 23. The latter has stator vanes 28 on a stator hub 26 and forms, together with the pump wheel 17 and the turbine wheel 19, a hydrodynamic circuit 24, which encloses an internal torus 25.

The stator 23 is mounted by its hub 26 on an outer body 106 of a freewheel 27, which is mounted by way of a rolling element part 108 on an inner body 110. Acting by way of a drive side thrust washer 112 and a takeoff side thrust washer 114, the outer body 106 centers the inner body 110 and is itself supported axially on the drive side via the drive side thrust washer 112, a drive side axial bearing 29, a turbine wheel hub 33, and a bearing 44 against the journal hub 12, whereas, on the takeoff side, it is supported via the takeoff side thrust washer 114 and a takeoff side axial bearing 35 against the pump wheel hub 11.

The stator 23 is connected nonrotatably but with freedom of axial movement to a support shaft 30 by means of a set of teeth 32 on the inner body 110 of its freewheel 27; this support shaft is mounted in such a way that it creates an essentially ring shaped, radially outer flow channel 41, located radially inside the pump wheel hub 11. The support shaft 30, which is designed as a hollow shaft, encloses in turn a gearbox input shaft 36, which acts as a takeoff 43, thus creating an essentially ring shaped, radially inner flow channel 42. The gearbox input shaft 36 is provided with a center bore 37 for the passage of clutch fluid. Whereas the two flow channels 41, 42 are provided to serve as the first flow route 130, the center bore 37 serves as a the second flow route 132. The gearbox input shaft 36 has a set of teeth 34 by which it accepts the previously mentioned turbine wheel hub 33 in nonrotatable but axially movable fashion and is sealed off against the journal hub 12 by a seal 50. By means of through rivets 49, the turbine wheel hub 33 is connected nonrotatably both to a turbine wheel base 31 of the turbine wheel 19 and to an outer plate carrier 92 of a bridging clutch 56.

The previously mentioned flow channels 41, 42 lead via openings 38, 39 in the thrust washers 112, 114, serving as the first pressure medium line 60, to the hydrodynamic circuit 24. The center bore 37, however, leads to a transition space 40, from which at least one channel 136 proceeds. This channel passes with a radial component through the journal hub 12 and serves as the second pressure medium line 62. This opens out into a pressure space 55 located axially between the housing cover 7 and a piston 54 of the bridging clutch 56. The housing cover 7 thus serves as the first wall 142 of the pressure space 55, and the side of the piston facing the pressure space 55 serves as the second wall 144 of the pressure space 55. The side of the piston 54 facing away from the piston space 55 borders the hydrodynamic circuit 24.

In its radially inner area, the piston 54 can be attached by rivets (not shown) and an intermediate axial spring 58 in the form of a set of tangential leaf springs to an anti-twist device 76, which is fastened to the journal hub 12 of the clutch housing 5.

Inside the pressure space 55, essentially in the central part of the radial extension of the piston 54, a radially inner plate carrier 86 is fastened by, for example, a weld, to the housing cover 7.

Depending on whether the first pressure medium line 60 or the second pressure medium line 62 is actuated and thus depending on the pressure relationships in the hydrodynamic circuit 24 and in the pressure space 55, the piston 54 can be moved in the axial direction between two different limit positions, namely, between its engaged position and its released position, which will be discussed in greater detail below. The piston 54 can be shifted axially by means of its base 52, which is supported on the journal hub 12, where a piston seal 63 recessed into the journal hub 12 seals off the gap between the base 52 and the hub.

A radially inner plate 65, which is connected nonrotatably by a set of teeth 88 to the radially inner plate carrier 86, is mounted axially between the housing cover 7 and the radially outer area of the piston 54. Radially outer plates 66, each of which is mounted nonrotatably by means of a set of teeth 90 on the radially outer plate carrier 92, are provided on both sides of the radially inner plate. Each of the two radially outer plates 66 has friction linings 68 on both sides, where the two friction linings 68 facing the radially inner plate 65 cooperate with friction zones on the radially inner plate 65 to form friction areas 69, whereas one of the friction linings 68 facing away from the radially inner plate 65 cooperates with a friction zone on the housing cover 7 to form a friction area 69, and the other one of these two friction linings 68 cooperates with a friction zone on the piston 54 to form a friction area 69.

The individual friction areas 69 are activated as soon as the friction linings 68 enter into working connection with their assigned friction zones, which happens as a result of the movement of the piston 54 into its engaged position and thus during the closing of the bridging clutch 56. The engagement of the piston 54 is complete when the piston 54 has come as close as possible axially, within its axial range of movement, to the housing cover 7. To initiate the engagement process, the pressure in the hydrodynamic circuit 24 must be higher than that in the pressure space 55.

Conversely, the individual friction areas 69 are deactivated as soon as the working connection between the friction linings 68 and their assigned friction zones is released, which is accomplished by the disengagement of the piston 54 and thus of the bridging clutch 56. The disengaging movement of the piston 54 is complete when the piston has moved axially as far away from the housing cover 7 as it can within its range of axial movement. To initiate the disengaging process, the pressure in the pressure space 55 and thus in the clutch space 61 must be higher than that in the hydrodynamic circuit 24.

The piston 54 of the bridging clutch 56 is engaged and disengaged as follows:

The previously mentioned flow channels 41, 42, the former located radially between the pump wheel hub 11 and the support shaft 30, the latter between the support shaft and the gearbox input shaft 36, supply the hydrodynamic circuit 24 with clutch fluid via the first pressure medium lines 60 and the openings 38, 39 in the thrust washers 112, 114, whereas the center bore 37 in the gearbox input shaft 36 supplies the pressure space 55 with clutch fluid via the transition space 40 and the second pressure medium lines 62. To guarantee the correct supply in each case, a pressure circuit 97, sketched in FIG. 1, is required. This circuit comprises a pressure source 93, driven in the conventional manner by a drive cam 94 on the pump wheel hub 11, whereas its suction side S can be connected to a fluid reservoir 95 and its delivery side D either to the flow channels 41, 42 or to the center bore 37. The clutch fluid is supplied to the flow channels 41, 42 or to the center bore 37 in accordance with the commands transmitted by an open-loop or closed loop control unit 100, which is referred to in brief as the controller 100, and which is in working connection both with a switching device 96 in the form of a switching valve 98 installed in the pressure circuit 97 and with the pressure source 93. Preferably the switching valve 98 is designed as a 4/2-port directional control valve, actuated by electromagnets 102, 104, which actuate the switching device 96 in accordance with the commands transmitted by the controller 100.

To deflect the piston 54 into the position shown in FIG. 1, the switching device 96 is actuated by the electromagnet 102 driven by the controller 100 in such a way that the magnet pushes the switching valve 88 from the position shown in FIG. 1 to a second position, in which the delivery side D of the pressure source 93 is connected to the flow channels 41, 42. The pressure in the channels therefore increases, whereas it decreases simultaneously in the center bore 37 of the gearbox input shaft 36, which is now connected via the switching valve 98 to the fluid reservoir 95.

The clutch fluid which has entered the flow channels 41, 42 arrives via the first pressure medium line 60 in the hydrodynamic circuit 24, and acts there on the piston 54, pushing it toward the pressure space 55, which empties through the second pressure medium line 62. Because of the positive pressure building up in the hydrodynamic circuit 24 versus the pressure space 55, force is exerted on the takeoff side piston wall 140 of the piston 54, as a result of which the displacement of the piston 54 toward the housing cover 7 is initiated.

So that the piston 54 can be returned to its released position, the switching device 96 is actuated by the electromagnet 104 under the command of the controller 100 in such a way that the electromagnet moves the switching valve 88 into the position shown in FIG. 1, in which the delivery side D of the pressure source 93 is connected to the center bore 37 of the gearbox input shaft 36. Thus the pressure increases there, whereas it decreases simultaneously in the flow channels 41, 42, which are now connected to the fluid reservoir 95 by the switching valve 98.

Because of this pressure and connection situation, clutch fluid is conducted from the fluid reservoir 95, via the center bore 37 of the gearbox input shaft 36 and the second pressure medium line 62, into the pressure space 55. Supported by the rotation of the clutch housing 5 around the axis of rotation 3, the clutch fluid does proceed radially outward. Because of its compact dimensions, the pressure space 55 is filled quickly, and thus a positive pressure versus the hydrodynamic circuit 24 builds up very quickly there.

So that the pressure in the pressure space 55 and that in the hydrodynamic circuit 24 can be equalized when the piston 54 is released, two substantially identical flow velocity influencing devices 150, 151 are provided, as shown in FIG. 1. These devices are described below.

The radially outer plate 66 adjacent to the piston 54 has a radially inward-pointing set of teeth 165, which engages nonrotatably with a set of teeth 167 on the first flow velocity influencing device 150 and thus ultimately also centers the first flow velocity influencing device 150 with respect to the axis of rotation 3. The radially outer plate carrier 92, connected for rotation in common to the plate 66, serves as the takeoff component 64 for this flow velocity influencing device 150. In contrast, the second flow velocity influencing device 151 is attached to the journal hub 12 and thus to the clutch housing 5 by means of the anti-twist device 76, serving as the drive component 78.

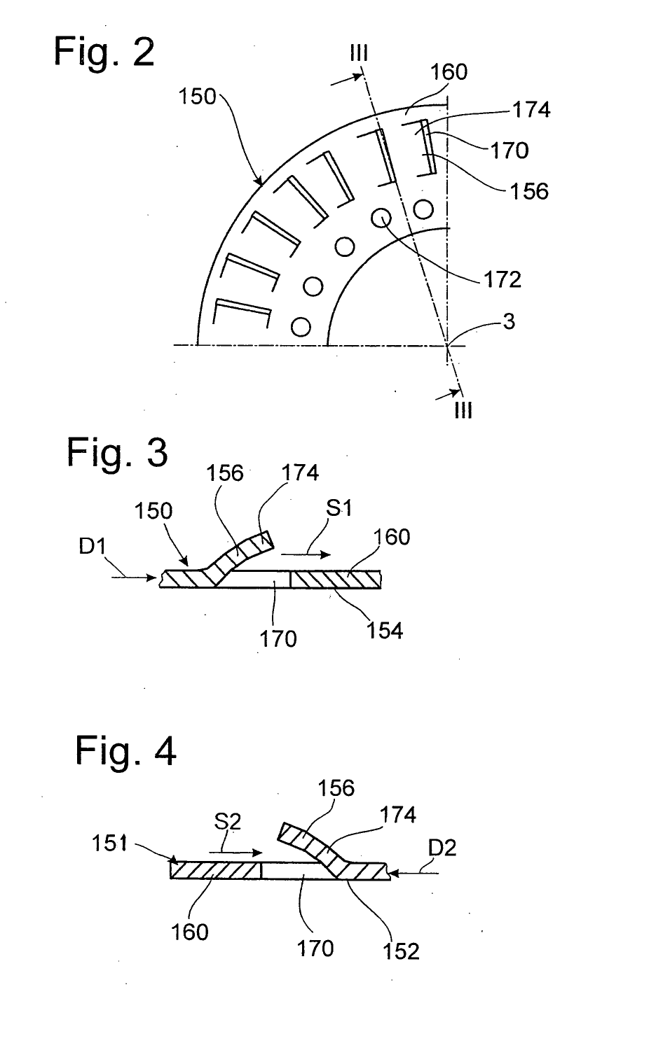

As FIGS. 2-4 show, each of the two flow velocity influencing devices 150, 151 has an essentially ring shaped base body 160, which is designed with flow velocity influencing elements 156. These can be in the form of tab-like flow guide elements 174, which proceed from the base body 160 and project into the flow path S1 or S2 of the clutch fluid as shown in either FIG. 3 or FIG. 4 to guide the clutch fluid into first openings 170 in the base body. It is also possible for the elements to be in the form of second openings 172 (FIG. 2) in the base body 160, into which the clutch fluid can flow. Regardless of their design in a specific case, the flow velocity influencing elements 156 accept clutch fluid in their openings 170, 172, but they also carry along the clutch fluid which adheres to the outside surfaces of the base body 160. Overall, because of the action of the flow velocity influencing elements 156, the flow velocity influencing devices 150 cause the flow velocity of the clutch fluid to approach its own rotational speed around the axis of rotation 3.

As FIG. 3 shows, the rotational direction D1 of the base body 160 can be the same as that of the flow path S1 of the clutch fluid, so that the flow velocity of the latter is increased. This will be the case when the first flow velocity influencing device 151 in FIG. 1 is in working connection via the plate 66, the radially outer plate carrier 92, and the turbine wheel hub 33 with the takeoff 43 and when, in push mode, the rpm's of the takeoff 43 are higher than those of the drive 2. The flow velocity influencing device 151 is then acting as a flow-accelerating device 154 and will therefore, in push mode of the hydrodynamic clutch device 1, increase the flow velocity of the clutch fluid in the pressure space 55.

As FIG. 4 shows, the rotational direction D2 of the base body 160 can also be opposite the flow route S2 of the clutch fluid, so that the flow velocity of the latter is reduced. This will be the case when the second flow velocity influencing device 150 in FIG. 1 is in working connection with the drive 2 via the anti-twist device 76, the clutch housing 5, the fastening mount 15, and the flexplate 8, and when, in push mode, the rpm's of the takeoff 43 are higher than those of the drive 2. The second flow velocity influencing device 151 is then acting as a flow-decelerating device 152 and will therefore, in push mode of the hydrodynamic clutch device 1, reduce the flow velocity of the clutch fluid in the hydrodynamic circuit 24.

Common to the two flow velocity influencing devices 150, 151 is that the flow guide elements 174 are fabricated by stamping from the rest of the base body 160, preferably on three sides, namely, at the radially outer side, at the radially inner side, and one of the circumferential sides. The openings 172 in the base body 160 can be produced at the same time.

The flow guide elements 174 which have thus been stamped are then plastically deformed (bent) to stand above the plane of the base body 160. As a result of this plastic deformation, the flow guide elements 174 stand above apertures 170 created in the base body 160 during the stamping process.

The base body 160 can also be plastically deformed to give it a stiffness-increasing profile. In FIG. 1, a profiling 162 is shown, which extends in the radial direction. Profilings in the circumferential direction, such as corrugations (not shown), could also be provided.

The two flow velocity influencing devices 150, 151 have the effect of equalizing the flow velocities of the clutch fluid in the hydrodynamic circuit 24 and the pressure space 55 precisely during operation in push mode, which is critical for the engaging process. Because the first flow velocity influencing device 150 in the pressure space 55 acts as a flow-accelerator 154, it has the effect of increasing the flow velocity in the pressure space 55, whereas the second flow velocity influencing device 151 in the hydrodynamic circuit 24, acting as a flow-decelerator 154, has the effect of reducing the flow velocity in the hydrodynamic circuit 24. Because the two different flow velocities on the different sides of the piston 54 of the bridging clutch 56 have been brought closer to each other, the pressure-increase curves in the corresponding pressure areas are also brought closer to each other than would be the case without the flow velocity influencing devices 150, 151. As a result, during operation in push mode, only a small positive pressure can build up in the pressure space 55, and thus only a slight positive pressure difference is sufficient during the subsequent supply of fluid to the hydrodynamic circuit 24 to engage the piston. The piston 54 can therefore be engaged softly and thus the bridging clutch 56 closed essentially without any torque surges.

So far, the hydrodynamic clutch device 1 has been described with two flow velocity influencing devices 150, 151. It is obvious, however, that one of the two flow velocity influencing devices could be omitted. That is, either the flow accelerator 154 will be present in the pressure space 55, or the flow-decelerator 152 will be present in the hydrodynamic circuit 24.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hydrodynamic clutch device comprising:
a pump wheel;
a housing connecting the pump wheel to a drive;
a turbine wheel connected to a takeoff, the turbine wheel being located in the housing and cooperating with the pump wheel to form a hydrodynamic circuit;
a bridging clutch located in the housing and comprising a piston separating a pressure space from the hydrodynamic circuit, the piston being movable between an engaged position, wherein the drive transmits torque to the takeoff via the bridging clutch, and a released position, wherein the drive transmits torque to the takeoff via the hydrodynamic circuit;
a pressure circuit comprising a first pressure medium line which supplies clutch fluid to the hydrodynamic circuit, and a second pressure medium line which supplies clutch fluid to the pressure space; and
a flow velocity influencing device located axially adjacent to the piston in at least one of the pressure space and the hydrodynamic circuit.

2. The hydrodynamic clutch device of claim 1 wherein the flow influencing device is located in the hydrodynamic circuit between the piston and the turbine wheel.

3. The hydrodynamic clutch device of claim 1 wherein the flow influencing device is located in the pressure space between the piston and the housing.

4. The hydrodynamic clutch device of claim 2 wherein the flow influencing device is connected to a drive component which is connected nonrotatably to the drive.

5. The hydrodynamic clutch device of claim 4 further comprising a journal hub fixed to the housing, wherein the drive component comprises an anti-twist device fastened to the journal hub, the anti-twist device preventing the piston from rotating with respect to the housing, the flow-influencing device being connected to the anti-twist device.

6. The hydrodynamic clutch device of claim 4 wherein the flow influencing device is connected nonrotatably to the drive component.

7. The hydrodynamic clutch device of claim 3 wherein the flow influencing device is connected to a takeoff component which is connected nonrotatably to the takeoff.

8. The hydrodynamic clutch device of claim 7 wherein the bridging clutch further comprises a plate carrier which is fixed nonrotatably to the takeoff, the takeoff component being formed by the plate carrier.

9. The hydrodynamic clutch device of claim 7 wherein the flow influencing device is connected nonrotatably to the takeoff component.

10. The hydrodynamic clutch device of claim 2 wherein the flow influencing device is a flow decelerating device.

11. The hydrodynamic clutch device of claim 1 wherein the flow influencing device is a flow accelerating device.

12. The hydrodynamic clutch device of claim 1 wherein the flow influencing device comprises a ring shaped base body.

13. The hydrodynamic clutch device of claim 12 wherein the ring shaped base body is formed with flow influencing elements.

14. The hydrodynamic clutch device of claim 13 wherein the base carrier comprises a plate and the flow influencing elements comprise guide elements which are stamped from the base body and formed to stand above the base body adjacent to apertures created in the base body during stamping.

15. The hydrodynamic clutch device of claim 12 wherein the ring shaped base body is provided with axial profiling to increase stiffness.
